(19) United States
(12) Patent Application Publication
(10) Pub. No.: US 2026/0312320 A1
(43) Pub. Date: Oct. 8, 2026

(54) ELECTRICAL CONNECTOR WITH IMPROVED TERMINALS

(71) Applicant: FOXCONN INTERCONNECT TECHNOLOGY LIMITED, Grand Cayman (KY)

(72) Inventors: FANG-JWU LIAO, New Taipei (TW); CHI-HSIANG LU, New Taipei (TW); JIA-HAU LIU, New Taipei (TW)

(21) Appl. No.: 19/635,725

(22) Filed: Mar. 31, 2026

(30) Foreign Application Priority Data
Apr. 2, 2025 (TW) 114112700

(51) Int. Cl. H01R 13/24; H01R 12/71

(52) U.S. Cl. CPC H01R 13/2435; H01R 12/716

(57) ABSTRACT

An electrical connector includes: an insulating housing having an upper face, a lower face, and plural terminal grooves penetrating the upper face and the lower face; and plural terminals retained in corresponding terminal grooves respectively, wherein each terminal includes a retaining portion fixed in the terminal groove, a first elastic arm extending upward from the retaining portion, a second elastic arm extending downward from the retaining portion, and a touching portion extending from the retaining portion and located between the first elastic arm and the second elastic arm in an upper-lower direction, a free end of the touching portion extends forward beyond foremost ends of the first elastic arm and the second elastic arm, and the first elastic arm and the second elastic arm move to abut against opposite sides of the touching portion when the first elastic arm and the second elastic arm are pressed.

### BACKGROUND OF THE INVENTION

### Field of the Invention

The present invention relates to an electrical connector.

### Description of Related Arts

U.S. Pat. No. 11,349,244 discloses an electrical connector having plural electrical contacts. The electrical contact includes an outer part and an inner part linked by a bridge. The outer part includes a retention section, a resilient upper contacting arm extending from the retention section with an upper mating apex and an upper abutment tip region, and a resilient lower contacting arm extending from the retention section with a lower mating apex and a lower abutment tip region. An upper abutment tab and a lower abutment tab extends upwardly and downwardly respectively from the retention section. The upper abutment tip region contacts with the upper abutment tab and the lower abutment tip region contacts with the lower abutment tab when the terminal is pressed. As both the upper abutment tip region and the lower abutment tip region need an independent abutment tab for contacting, it is hard and high-cost to process the contact with two abutment tabs.

Therefore, it is desired to provide an electrical connector with improved terminals.

### SUMMARY OF THE INVENTION

An object of the present invention is to provide an electrical connector with improved terminals.

To achieve the above object, an electrical connector includes: an insulating housing having an upper face, a lower face, and a plurality of terminal grooves penetrating the upper face and the lower face in an upper-lower direction; and a plurality of terminals retained in corresponding terminal grooves respectively, wherein each terminal includes a plate-shaped retaining portion fixed in the terminal groove, a first elastic arm extending upward from an upper edge of the retaining portion, a second elastic arm extending downward from a lower edge of the retaining portion, and a touching portion extending forward from the retaining portion and located between the first elastic arm and the second elastic arm in the upper-lower direction, a free end of the touching portion extends forward beyond foremost ends of the first elastic arm and the second elastic arm, and the first elastic arm and the second elastic arm move to abut against opposite sides of the touching portion when the first elastic arm and the second elastic arm are pressed.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of an embodiment of this invention, wherein two terminals are separated from an insulating housing;

FIG. 2 is another perspective view of the electrical connector in FIG. 1;

FIG. 3 is an enlarged perspective view of a part of the insulating housing viewed in a lower to upper direction, to show the terminal grooves;

FIG. 4 is an enlarged perspective view of a part of the insulating housing viewed in an upper to lower direction;

FIG. 5 is an enlarged perspective view of a part of the the electrical connector viewed in the lower to upper direction to show the terminal in the terminal grooves;

FIG. 6 is an enlarged perspective view of a part of the electrical connector viewed in the upper to lower direction;

FIG. 7 is a perspective view of the terminal in FIG. 1;

FIG. 8 is another perspective view of the terminal in FIG. 7;

FIG. 9 is a perspective view of the terminal when the terminal is pressed;

FIG. 10 is another perspective view of the terminal in FIG. 8;

FIG. 11 is a side view of the terminal in FIG. 7;

FIG. 12 is a side view of the terminal in FIG. 9;

FIG. 13 is a cross sectional view of the electrical connector taken along line A-A of FIG. 1; and

FIG. 14 is a cross sectional view of the electrical connector when the terminal is pressed.

### DETAILED DESCRIPTION OF THE PREFERRED EMBODIMENT

Reference will now be made in detail to the preferred embodiments of the present invention.

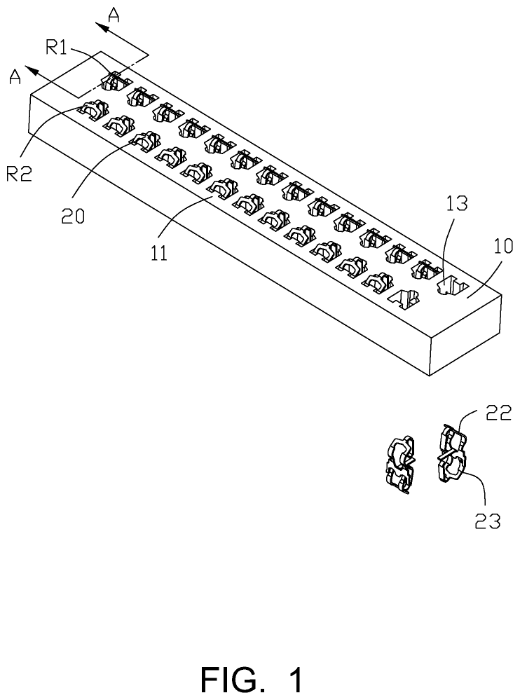

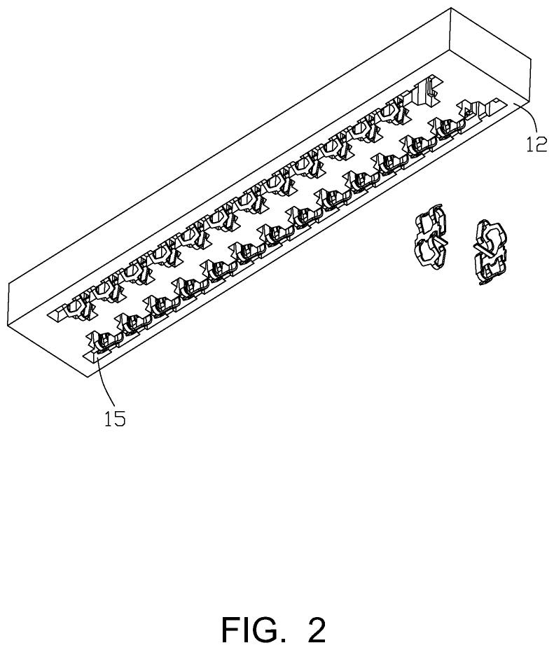

Referring to FIGS. 1-2, an electrical connector 100 is used for electrically connecting an electrical module, e.g., a chip module, to a circuit board or connecting two circuit boards of an embodiment. The electrical connector 100 includes an insulating housing 10 and a plurality of terminals 20 arranged in a matrix. The insulating housing 10 has an upper face 11, a lower surface 12, and plural terminal grooves 13 penetrating the upper face 11 and the lower face 12. The terminals 20 are disposed in the terminal grooves 13 one by one. It should be noted that, the electrical connector 100 has hundreds of terminals. In this embodiment, only two rows of terminals 20, namely, the first row of terminals R1 and the second row of terminals R2, and the corresponding terminal grooves 13 for receiving the terminals are illustrated. Each row of terminals 20 is arranged along a first direction i.e., a left-right direction shown in FIG. 1, and the first row R1 and the second row R2 are arranged side by side along a second direction perpendicular to the first direction. The first row R1 of terminals and the second row R2 of terminals are staggered along the first direction. Preferably, the terminals 20 of the second row R2 are positioned directly opposite gaps between two adjacent terminals 20 in the first row R1, and likewise, the terminals 20 of the first row R1 are positioned directly opposite gaps between two adjacent terminals 20 in the second row R2.

The first row R1 of terminals and the second row R2 of terminals are disposed face to face along the second direction, that is, the elastic arms of the terminals of the first row R1 bend from their respective retaining portions and toward the second row R2 of terminals, while the elastic arms of the terminals of the second row R2 bend from their respective retaining portions and toward the first row R1 of terminals. In actual products, the electrical connector 100 includes plural rows of terminals 20 arranged in the first direction and set side by side in the second direction. The rows of terminals are divided into two zones, referred to as a first zone and a second zone. All the elastic arms of the terminals 20 in the first zone extend toward the second zone while all the elastic arms of the terminals 20 in the second zone extend toward the first zone.

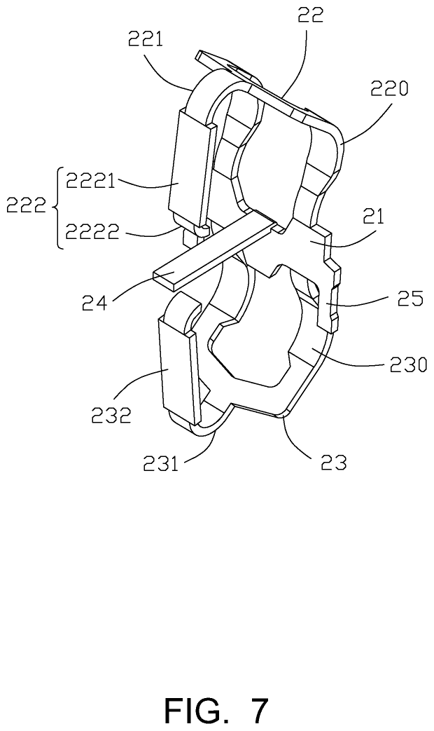

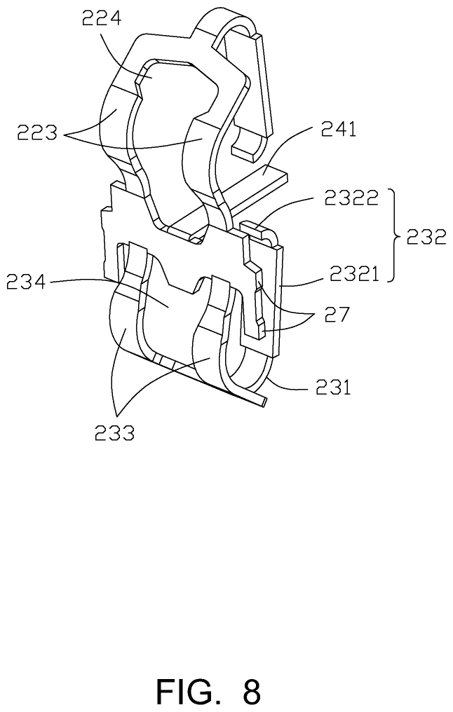

Referring to FIGS. 7-8, each terminal 20 includes a retaining portion 21 retained in the terminal groove 13, a first elastic arm/upper elastic arm 22 and a second elastic arm/lower elastic arm 23 extending from the retaining portion 21 respectively. The upper elastic arm 22 is located above the retaining portion 21, and the lower elastic arm 23 is located below the retaining portion 21. The terminal 20 further includes a touching portion 24 extending from the retaining portion 21, and both the upper elastic arm 22 and the lower elastic arm 23 of a terminal abut against the same touching portion 24 when the terminals 20 is pressed. The upper elastic arm 22 sequentially includes a first elastic portion/an upper elastic portion 220, a first contacting portion/an upper contacting portion 221, and a first abutting portion/an upper abutting portion 222. The lower elastic arm 23 sequentially includes a second elastic portion/a lower elastic portion 230, a second contacting portion/a lower contacting portion 231, and a second abutting portion/a lower abutting portion 232. The retaining portion 21 extends vertically. The touching portion 24 is plate-like and is perpendicular to the retaining portion 21.

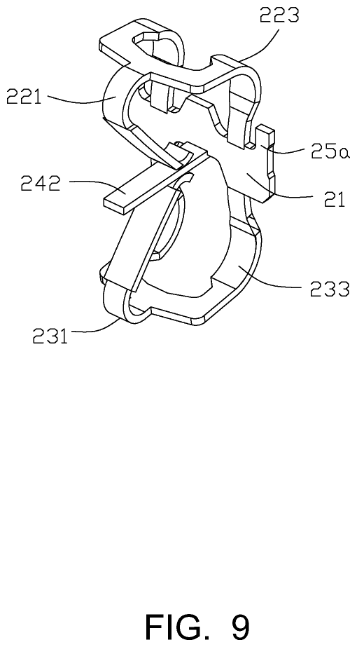

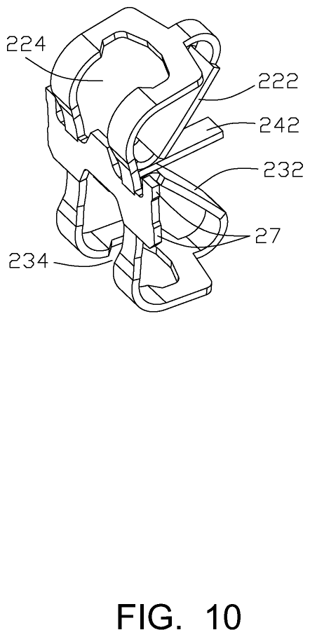

Combined with FIGS. 9-10, the first abutting portion 222 abuts against the upper face 241 of the touching portion 24, and the second abutting portion 232 abuts against the lower face 242 of the touching portion 24 when the terminal 20 is pressed. The touching portion 24 extending horizontally from the retaining portion 21 makes the upper elastic arm 22 and the lower elastic arm 23 contact the touching portion 24 easily, thereby ensuring a stable transmission for the electrical connector 100. The first elastic portion 220 includes two first supporting arms 223 spaced apart from each other, and the second elastic portion 230 includes two second supporting arms 233 spaced apart from each other. The touching portion 24 is formed by cutting and bending a middle portion between the two second supporting arms 233 of the second elastic portion 230. Preferably, a junction of the touching portion 24 and the retaining portion 21 is near a middle portion of the retaining potion along an upper-lower direction, that is, the junction of the touching portion 24 and the retaining portion 21 is at a higher level than a lower edge of thereof, and thus, the touching portion 24 can be located in a right middle of the upper elastic arm 22 and the lower elastic arm 23 along the upper-lower direction. Alternatively, the touching portion 24 is formed by cutting and bending a middle portion between the two first supporting arms 223 of the first elastic portion 220. Combined with FIGS. 1-2, the touching portions 24 in the first zone extend from corresponding retaining portions 21 toward the second zone, and the touching portions 24 in the second zone extend from corresponding retaining portions 21 toward the first zone. Two adjacent rows of terminals 20 are staggered along the second direction.

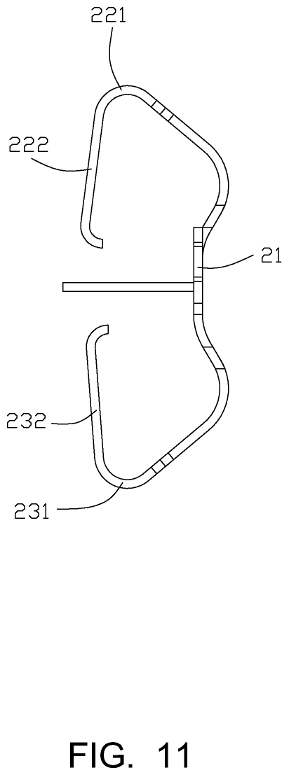

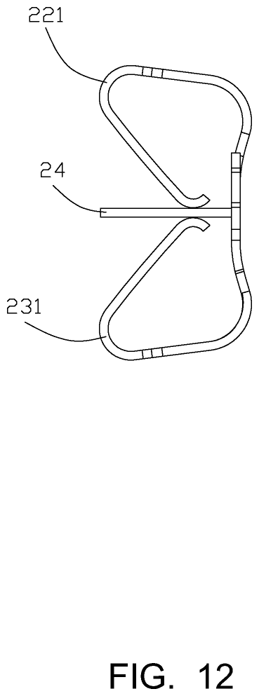

Referring to FIGS. 11-13, in the embodiment, both the first elastic portion 220 and the second elastic portion 230 protrude backward in an arc shape and are beyond a plane where the retaining portion is located, making the first elastic portion 220 and the second elastic portion 230 elastic enough to deform. Combined with FIGS. 7-10, both the first elastic portion and the second elastic portion includes a slot and two supporting arms at two sides of the slot. Preferably, the first elastic portion 220 includes a slot 224, and the two first supporting arms 223 are located at two sides of the slot 224. The second elastic portion includes a slot 234, and the two second supporting arms 233 are located on two sides of the slot 234. The first abutting portion 222 includes a first straight portion 2221 extending downward from the first contacting portion 221, and a first mating portion 2222 bending inward from the first straight portion 2221. The second abutting portion 232 includes a second straight portion 2321 extending upward from the second contacting portion 231 and a second matting portion 2322 bent inward from the second straight portion 2321. A width of the first straight portion 2221 is greater than that of the first contacting portion 221 and the first mating portion 2222, and a width of the second straight portion 2321 is greater than that of the second contacting portion 231 and the second abutting portion 2322. Both a contacting point between the upper elastic arm 22 and the touching portion 24 and a contacting point between the lower elastic arm 23 and the touching portion 24 are close to the retaining portion 21 when the upper elastic arm 22 and the lower elastic arm 23 are pressed. In order to facilitate the upper elastic arm 22 and the lower elastic arm 23 to contact the touching portion 24 when pressed, the touching portion 24 extends forward beyond the foremost ends of the upper elastic arms 22 and the lower elastic arm 23.

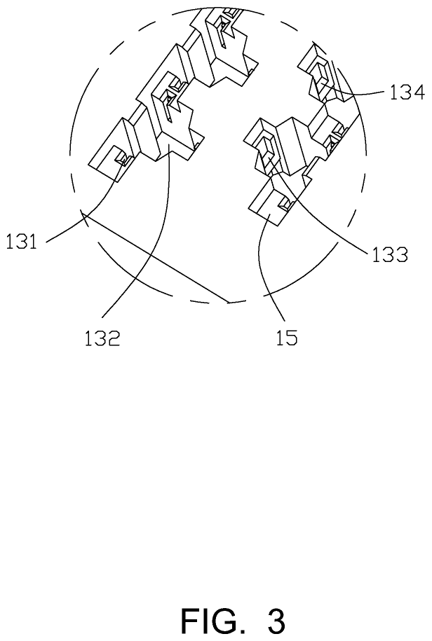

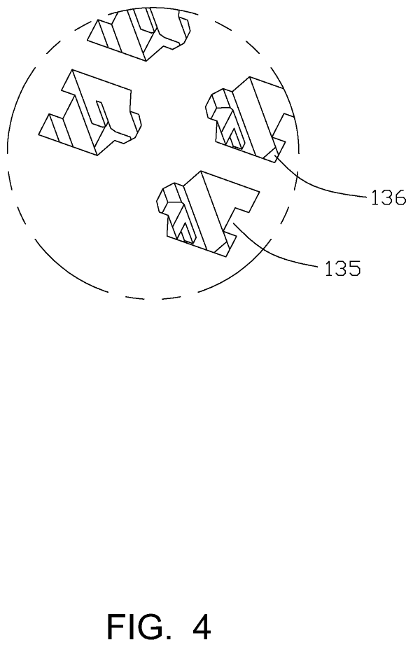

Referring to FIGS. 3-6, the terminal groove 13 includes a retaining slot 131 for receiving the retaining portion 121, a receiving groove 132 communicating with the retaining slot 131 and penetrating through the upper face 11 and the lower face 12 of the insulating housing, and a blocking groove 133 communicating with the receiving groove 132. The upper elastic arm 22 and the lower elastic arm 23 are received in the receiving groove 132, the touching portion 24 extends forward through the receiving groove 132 and into the blocking groove 133, and a front end of the touching portion 24 abuts against an abuttingwall 134 of the blocking groove 133 along the upper-lower direction. The terminal 20 is inserted into the terminal groove 13 from an inserting direction, and the abutting wall 134 of the blocking groove 133 faces the inserting direction. Preferably, the blocking groove 133 penetrates through the upper or lower face of the insulating housing 10 in the vertical direction, that is, the blocking groove 133 has an opening facing upward or facing downward.

In the embodiment, both the blocking groove 133 and the retaining slot 131 open downward, and the terminals 20 are inserted into the terminal grooves 13 from a lower-upper direction. The retaining portions 121 are held within the retaining slots 131 and the front ends of the touching portions 24 abut against corresponding abutting walls 134 of the blocking grooves 133 when the terminals are fully inserted, thereby making the terminals 20 stably retained within the terminal grooves 13. Similarly, in other embodiments, the blocking groove 133 and the retaining slot 131 may open upward, and the terminals 20 can be installed into the terminal grooves 13 from an upper-lower direction. The terminal groove 13 further includes a rib portion 135 protruding forward from a rear wall thereof and two accommodating grooves 136 located at two sides of the rib portion 135 respectively. The rib portion 135 is behind the retaining portion 21. The rib portions 135 go into the slots 224, 234 and the first supporting arm 223 and the second supporting arm 233 are respectively located in the corresponding accommodating grooves 136.

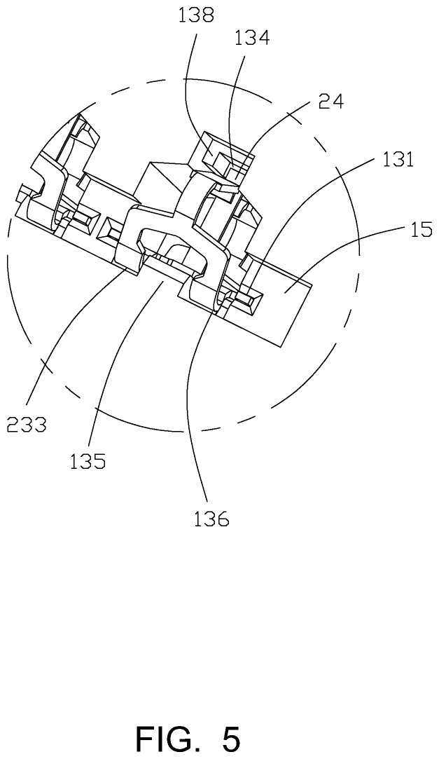

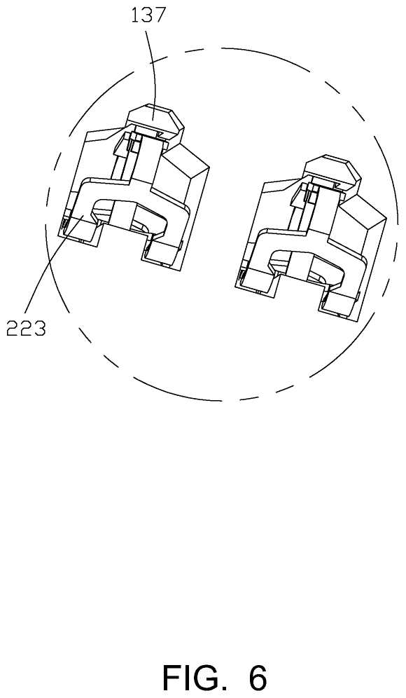

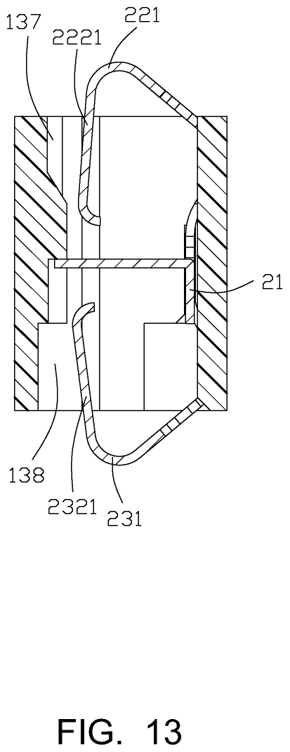

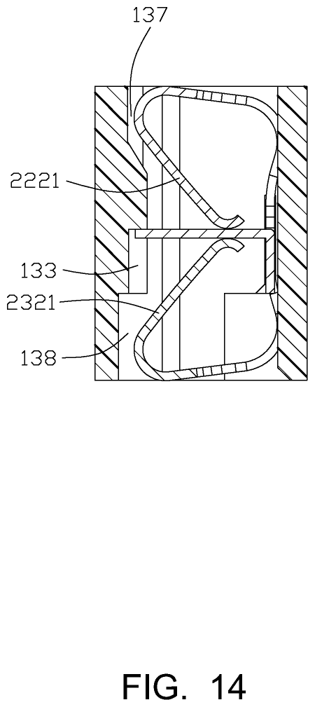

Referring to FIGS. 5-6, the terminal groove 13 also includes an upper avoiding groove 137 and a lower avoiding groove 138 in front of the receiving groove 132 for accommodating the deformed terminal 20 when the terminal is pressed. Preferably, the upper avoiding groove 137 opens upward and the lower avoiding groove 138 opens downward. The blocking groove 133 opens downward and is exposed within the lower avoiding groove 138. Combined with FIG. 13, both the first straight portion 2221 and the second straight portion 2321 are generally vertical, and the upper elastic arm 22 does not go into the corresponding upper avoiding groove 137 and the lower elastic arm 23 does not go into the corresponding lower avoiding groove 138 when the terminal 20 is in a free state. Combined with FIG. 14, the upper elastic arm 22 partially goes into the corresponding upper avoiding groove 137 and the lower elastic arm 23 partially goes into the corresponding lower avoiding groove 138 when the terminal is pressed. Preferably, the upper contacting portion 221 of the upper elastic arm 22 goes into the corresponding upper avoiding groove 137 and the lower contacting portion 231 of the lower elastic arm 23 goes into the corresponding lower avoiding groove 138.

As shown in FIGS. 7-8, in order to securely fix the terminal 20 into the terminal groove 13, the retaining portion 21 includes plural barbs at two outer side edges thereof. The terminal 20 also includes two strip connecting portions 25 extending vertically from two sides of the retaining portion 21 respectively. Preferably, barbs 27 are at outer edges of both retaining portion 21 and the strip connecting portions 25. The barbs 27 of the retaining portion are near the strip connecting portions 25 and the barbs of the strip connecting are at free ends of the strip connecting portions 25. As the touching portion 24 bending from the retaining portion, the retaining portion must have a certain height along the upper-lower direction to provide sufficient strength to support the touching portion 24. If the outer edges of retaining portion 21 away from the strip connecting portions 25 are also provided with barbs 27, an installation of the terminal 20 would be difficult as the retaining portion 21 is hard to deform. As shown in FIGS. 9-14, the outer side edges of both the strip connecting portion 25 and the retaining portion 21 are provided with barbs 27, and the barbs 27 at the outer side edges of the retaining portion 21 are away from the strip connecting portions 25, therefore, the barbs 27 of the terminal 20 are widely distributed along the upper-lower direction. Due to the long distribution of the barbs 27, it is difficult to install the terminals 20. Referring to FIGS. 7-8, differing from the terminal shown in FIGS. 9-14, as the barbs 27 of the retaining portion 21 are near the strip connecting portions 25 and the strip connecting portions 25 with the barbs 27 are easy to deform, it is convenient to install the terminals 20.

Referring to FIG. 14, as the terminal 20 is substantially entirely located within the insulating housing 10 when the terminal 20 is pressed, the insulating housing 10 should thick enough to accommodate the terminal 20. Referring to FIGS. 2 and 5, in order to facilitate the installation of terminal 20, the terminal groove 13 also includes an installation slot 15 recessed inward from the upper face 11 or the lower face 12 of the insulating housing 10. Multiple installation slots 15 are arranged side by side and form an integrated long slot, and openings of the retaining slots 131 are exposed within the installation slot 15.

The above introduces the integrally formed terminal 20 and the corresponding grooves 13. It can be understood that, in other embodiments the terminal 20 can also be configured in a separated manner, i.e., the touching portion 24 and the retaining portion 21 of terminal 20 can be formed separately, and the touching portion 24 can be connected to the retaining portion 21 by welding or other means.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulating housing having an upper face, a lower face, and a plurality of terminal grooves penetrating the upper face and the lower face in an upper-lower direction; and
a plurality of terminals retained in corresponding terminal grooves respectively;
wherein each terminal comprises a plate-shaped retaining portion fixed in the terminal groove, a first elastic arm extending upward from an upper edge of the retaining portion, a second elastic arm extending downward from a lower edge of the retaining portion, and a touching portion extending forward from the retaining portion and located between the first elastic arm and the second elastic arm in the upper-lower direction, a free end of the touching portion extends forward beyond foremost ends of the first elastic arm and the second elastic arm, and the first elastic arm and the second elastic arm move to abut against opposite sides of the touching portion when the first elastic arm and the second elastic arm are pressed.

2. The electrical connector as claimed in claim 1, wherein the retaining portion extends vertically along the upper-lower direction, the touching portion extends horizontally in a plate shape and is perpendicular to the retaining portion, and the first elastic arm is movable to abut against an upper face of the touching portion and the second elastic arm is movable to abut against a lower face of the touching portion.

3. The electrical connector as claimed in claim 2, wherein the first elastic arm sequentially comprises a first elastic portion, a first contacting portion, and a first abutting portion, the second elastic arm sequentially comprises a second elastic portion, a second contacting portion, and a second abutting portion, and the first abutting portion is adapted to abut against the upper face of the touching portion and the second abutting portion is adapted to abut against the lower face of the touching portion.

4. The electrical connector as claimed in claim 3, wherein the first elastic portion comprises two spaced first supporting arms, the touching portion is formed by cutting and bending a middle portion between the two first supporting arms of the first elastic portion, the second elastic portion comprises two spaced second supporting arms, and the touching portion is formed by cutting and bending a middle portion between the two second supporting arms of the second elastic portion.

5. The electrical connector as claimed in claim 3, wherein the first abutting portion comprises a first straight portion extending downward from the first contacting portion and a first mating portion bending inward from the first straight portion, and the second abutting portion includes a second straight portion extending upward from the second contacting portion and a second mating portion bending inward from the second straight portion.

6. The electrical connector as claimed in claim 1, wherein the terminal groove comprises a retaining slot with an opening for receiving the retaining portion, a receiving groove communicating with the retaining slot and penetrating the upper face and the lower face of the insulating housing, and a blocking groove communicating with the receiving groove, the first elastic arm and the second elastic arm are received in the receiving groove, and a free end of the touching portion abuts against an abutting wall of the blocking groove along the upper-lower direction.

7. The electrical connector as claimed in claim 6, wherein the retaining portion extends vertically, the first elastic arm sequentially comprises a first elastic portion, a first contacting portion, and a first abutting portion, the second elastic arm sequentially comprises a second elastic portion, a second contacting portion, and a second abutting portion, and the first elastic portion and the second elastic portion protrude backward in an arc shape and are beyond a plane where the retaining portion is located.

8. The electrical connector as claimed in claim 7, wherein each of the first elastic portion and the second elastic portion comprises a slot and two supporting arms at two sides of the slot.

9. The electrical connector as claimed in claim 8, wherein the receiving groove comprises a rib portion and two accommodating grooves at two opposite sides of the rib portion, the rib portion extends into the slots, and the supporting arms are respectively located in the corresponding accommodating grooves.

10. The electrical connector as claimed in claim 8, wherein the terminal includes two strip connecting portions extending vertically from two sides of the retaining portion respectively.

11. An electrical connector comprising:
an insulating housing having an upper face, a lower face, and a plurality of terminal grooves penetrating the upper face and the lower face; and
a plurality of terminals retained in corresponding terminal grooves respectively;
wherein each terminal groove comprises a retaining slot, a receiving groove communicating with the retaining slot, and a blocking groove communicating with the receiving groove, each terminal comprises a retaining portion fixed in the retaining slot, an upper elastic arm and a lower elastic arm received in the receiving groove, and a touching portion extending forward from the retaining portion, the touching portion extends into the blocking groove through the receiving groove and abuts against a bottom wall of the blocking groove along an upper-lower direction, and the upper elastic arm moves to abut against an upper face of the touching portion and the lower elastic arm moves to abut against a lower face of the touching portion when the upper elastic arm and the lower elastic arm are pressed.

12. The electrical connector as claimed in claim 11, wherein the terminals are divided into a first zone and a second zone, the upper elastic arms and lower elastic arms of the terminals in the first zone extend from corresponding retaining portions and toward the second zone, and the upper elastic arms and lower elastic arms of the terminals in the second zone extend from corresponding retaining portions and toward the first zone.

13. The electrical connector as claimed in claim 11, wherein the terminal groove further comprises an upper avoiding groove opening upward and a lower avoiding groove opening downward, and the upper elastic arm is deformed to go into the upper avoiding groove and the lower elastic arm is deformed to go into the lower avoiding groove when the upper elastic arm and the lower elastic arm are pressed.

14. The electrical connector as claimed in claim 13, wherein the blocking groove is exposed to the upper avoiding groove or to the lower avoiding groove.

15. An electrical connector comprising:
an insulating housing having an upper face, a lower face, and a plurality of terminal grooves penetrating the upper face and the lower face; and
a plurality of rows of terminals retained in corresponding terminal grooves and divided into a first zone and a second zone;
wherein each terminal comprises a retaining portion fixed in the terminal groove, a touching portion extending from the retaining portion, and an upper elastic arm with an upper contacting portion exposed to the upper face and a lower elastic arm with a lower contacting portion exposed to the lower face, the touching portions of the terminals in the first zone extend toward the second zone and the touching portions of the terminals in the second zone extend toward the first zone, and each upper elastic arm is movable to abut against an upper face of the touching portion and the lower elastic arm is movable to abut against a lower face of the touching portion.

16. The electrical connector as claimed in claim 15, wherein each row of terminals are arranged along a first direction and two adjacent rows of terminals are staggered along the first direction.

17. The electrical connector as claimed in claim 15, wherein each terminal groove has a rib portion, each of the upper elastic arms and the lower elastic arms has a slot, and the rib portion goes into the slots of the terminal.
